(19) United States
(12) Patent Application Publication
(10) Pub. No.: US 2006/0239169 A1
(43) Pub. Date: Oct. 26, 2006

(54) Optical head device and manufacturing method therefor

(76) Inventors: Hiromasa Marumo, Nagano (JP); Yasuyuki Tsukioka, Nagano (JP)

Correspondence Address: CANTOR COLBURN, LLP, 55 GRIFFIN ROAD SOUTH, BLOOMFIELD, CT, 06002, US

(21) Appl. No.: 11/403,256

(22) Filed: Apr. 13, 2006

(30) Foreign Application Priority Data
Apr. 21, 2005 (JP) 2005-123127

(51) Int. Cl. G11B 7/00

(52) U.S. Cl. 369/100

(57) ABSTRACT

An optical head device, for use with an optical disk, may include a laser beam emitting element, a light receiving element for receiving a reflected light beam emitted from the laser beam emitting element and reflected by the optical disk, a frame on which the laser beam emitting element and the light receiving element are mounted, and an adhesive which contains heat-conductive fillers having superior thermal conductivity to adhesively fix the laser beam emitting element or the light receiving element to the frame. The adhesive may be preferably a photo-curing type of adhesive which contains heat-conductive fillers and is also capable of being cured by applying heat.

### CROSS REFERENCE TO RELATED APPLICATION

The present invention claims priority under 35 U.S.C. §119 to Japanese Application No. 2005-123127 filed Apr. 21, 2005, which is incorporated herein by reference.

### FIELD OF THE INVENTION

An embodiment of the present invention may relate to an optical head device which is used to record or reproduce information on or from an optical disk such as a CD or a DVD and may relate to a manufacturing method for the optical head device. More specifically, an embodiment of the present invention may relate to a heat dissipation structure for a laser beam emitting element which is provided in an optical head device and may relate to a manufacturing method for the heat dissipation structure provided in the optical head device.

### BACKGROUND OF THE INVENTION

An optical head device which is used to record or reproduce information on or from an optical disk such as a CD or a DVD includes a laser beam emitting element as a light source and a frame for mounting the laser beam emitting element.

In this type of an optical head device, after the laser beam emitting element is fixed to a holder, the adjustment of the optical axis of the laser beam emitting element is performed by an optical axis adjusting equipment while the holder is held, and then the holder and the frame are adhesively fixed. The structure of a conventional optical head device 101 will be described more specifically with reference to FIG. 6.

As shown in FIG. 6, in a conventional optical head device 101, a laser beam emitting element 102 is lightly press-fitted to a through-hole (not shown) which is formed in a holder 103 and adhesively bonded with an anaerobic adhesive in a reinforced manner. The holder 103 is adhesively fixed to a frame 104 such that the opposite face 106 of the holder 103 to the frame 104 in an optical axis direction is fixed to the frame 104 by using an adhesive 105. In FIG. 6, heat dissipation grease is not applied but the heat dissipation grease may be used so as to contact with both the side face of the holder 103 and the frame 104. The heat dissipation grease is superior to an adhesive 105 in thermal conductivity and heat generated in the laser beam emitting element 102 can be dissipated from the holder 103 to the frame 104.

In the conventional optical head device 101, since the holder 103 is adhesively fixed to the frame 104 by an adhesive 105, the holder 103 can be simply and easily fixed to the frame 104 in comparison with fixing with the use of soldering or a screw. However, the thermal conductivity of the adhesive 105 is low and thus heat generated in the laser beam emitting element 102 cannot be easily dissipated from the holder 103 to the frame 104. It is conceivable that heat dissipation grease which is superior in thermal conductivity is utilized but the number of components increases. Also, another step for applying heat dissipation grease after an adhesive applying step is required and thus workability is impaired. In addition, the positional accuracy of the laser beam emitting element 102 is impaired by shrinkage at the time of curing of the adhesive 105 and shrinkage due to aging. Further, in the case that heat dissipation grease is applied, the heat dissipation grease is required to be applied to the side face of the holder 103 and thus its contacting area is small and a sufficient heat dissipation effect cannot be obtained.

### BRIEF DESCRIPTION OF THE INVENTION

In view of the problems described above, an embodiment of the present invention may advantageously provide an optical head device which uses adhesive and which is capable of obtaining a superior heat dissipation effect compared to prior art adhesives but without using heat dissipation grease and is capable of restraining the shrinkage at the time of curing of adhesive and the shrinkage by aging, and may advantageously provide a manufacturing method for the optical head device.

Thus, according to an embodiment of the present invention, there may be provided an optical head device, for use with an optical disk, including a laser beam emitting element as a light source, a light receiving element for receiving a reflected light beam which is emitted from the laser beam emitting element to the optical disk and reflected by the optical disk, a frame on which the laser beam emitting element and the light receiving element are mounted, and an adhesive which contains heat-conductive fillers with superior thermal conductivity compared to standard adhesive without heat conductive fillers for adhesively fixing the laser beam emitting element or the light receiving element to the frame.

In accordance with an embodiment, the heat-conductive fillers may comprise powder of metal or nitride or other materials.

In accordance with an embodiment, the adhesive is preferably disposed in a gap space, which is formed between the frame and the laser beam emitting element, for adjusting the optical axis of the laser beam emitting element in an optical axis direction. According to the structure described above, the adhesive can be disposed by utilizing the gap space which is required to adjust the optical axis of the laser beam emitting element. Therefore, the optical head device can be made compact in the radial direction in comparison with a conventional optical head device in which heat dissipation grease is applied to the outer side of the gap space.

In accordance with an embodiment, the adhesive is preferably a photo-curing type of adhesive which is also capable of being cured by heat. When metal powder or nitride are contained in the photo-curing type of adhesive, light is shaded by the metal powder or the nitride and thus the complete curing of the photo-curing type of adhesive may be difficult with the use of only light. However, according to the structure as described above, even when the adhesive has not been sufficiently cured by only light, the adhesive can be completely cured by applying heat afterward. In other words, after the optical axis of the laser beam emitting element has been adjusted, the adhesive is cured by light quickly to keep the position of the laser beam emitting element and then, the adhesive can be completely cured by applying heat afterward.

In accordance with an embodiment, the optical head device includes a holder which is provided with a through-hole formed in an optical axis direction on which the laser beam emitting element is mounted, and the holder is provided with an opposite face which faces the frame in the optical axis direction and the adhesive is disposed in the gap space between the opposite face of the holder and the frame. According to the structure as described above, the holder can be formed in a shape which is easily held by an optical axis adjusting equipment and thus the holder can be more easily and surely held in comparison with the case that a general-purpose laser beam emitting element itself is held by the optical axis adjusting equipment. As a result, workability for adjusting the optical axis of the laser beam emitting element is also improved. Further, when the holder is formed to be provided with a portion protruded larger in the direction perpendicular to the optical axis direction than the stem of the laser beam emitting element, the contact area of the adhesive to the holder can be made larger and thus heat generated in the laser beam emitting element can be effectively dissipated to the frame through the holder.

As described above, according to the optical head device in accordance with an embodiment, the laser beam emitting element or the light receiving element is adhesively fixed to the frame with the adhesive which contains heat-conductive fillers. Therefore, even when the laser beam emitting element or the light receiving element is fixed to the frame with the adhesive, heat generated in the laser beam emitting element or the light receiving element is dissipated to the frame through the heat-conductive fillers which are contained in the adhesive. As a result, superior heat dissipation effect can be obtained without using heat dissipation grease. Furthermore, shrinkage at the time of curing of the adhesive and shrinkage due to aging can be restrained by the heat-conductive fillers.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an optical head device in accordance with an embodiment of the present invention which is viewed from obliquely above.

FIG. 2 is an explanatory view showing the structure of an optical system in the optical head device which is shown in FIG. 1.

FIG. 3 is a bottom view showing the optical head device shown in FIG. 1, in which a cover of the optical head device is detached.

FIG. 4 is a side view showing a side face in the tracking direction of the optical head device which is shown in FIG. 1.

FIG. 5 is a bottom view showing a bottom face of the optical head device which is shown in FIG. 1.

FIG. 6 is an enlarged view showing an adhered portion between a holder and a frame in a conventional optical head device.

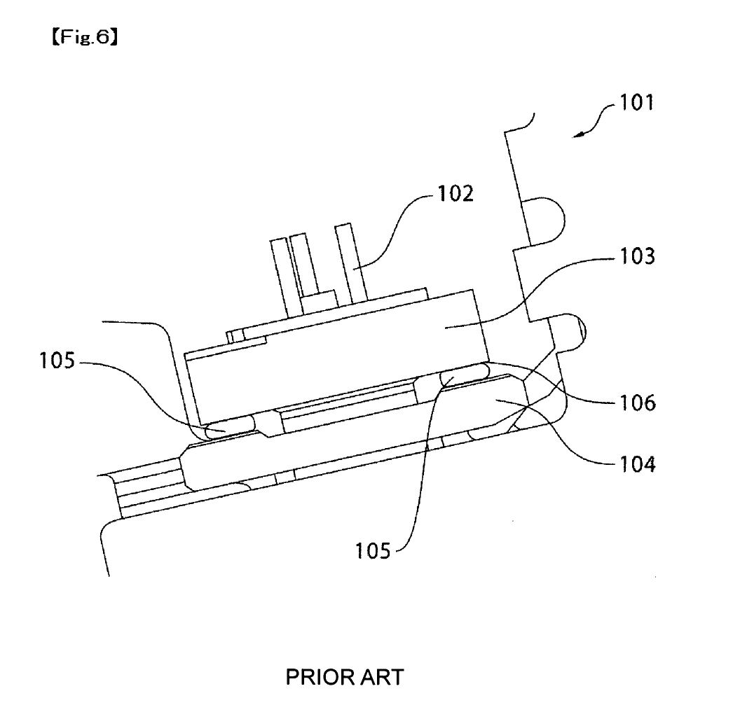

### DETAILED DESCRIPTION OF THE PREFERRED EMBODIMENTS

An optical head device in accordance with an embodiment of the present invention will be described below with reference to the accompanying drawings.

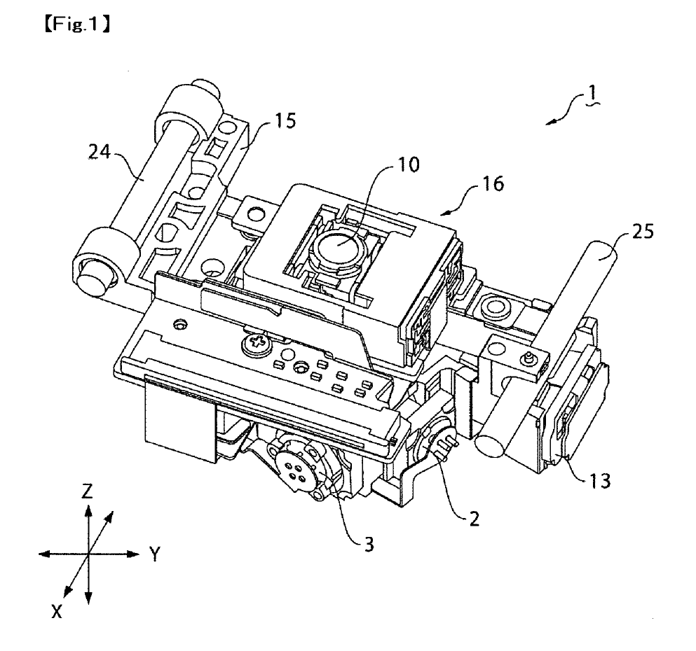

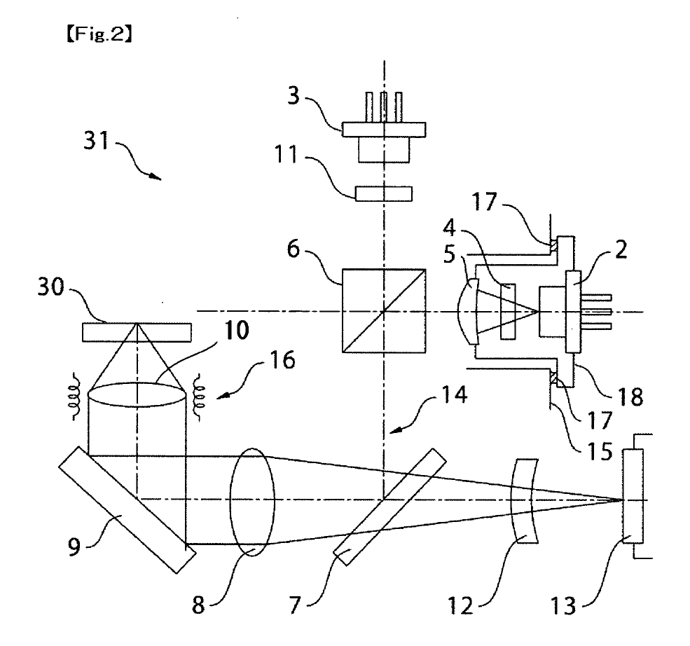

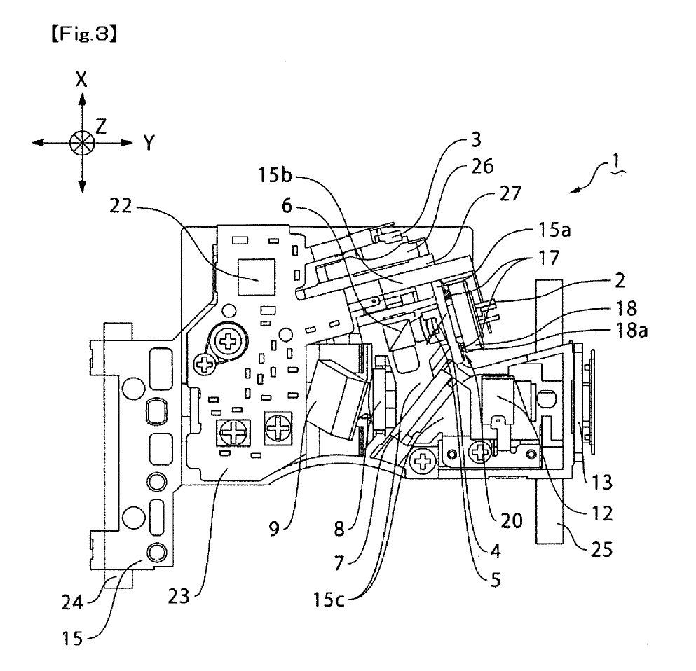

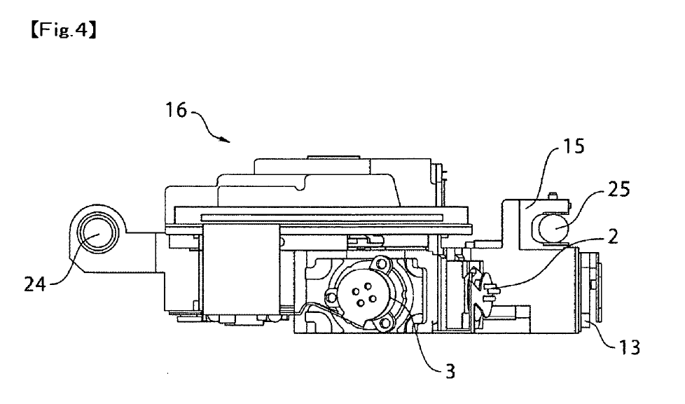

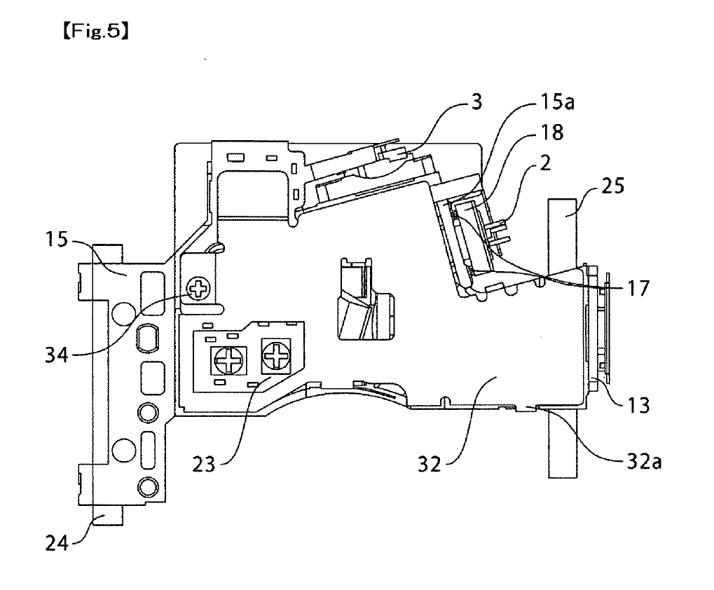

FIG. 1 is a perspective view showing an optical head device in accordance with an embodiment which is viewed from obliquely above. FIG. 2 is an explanatory view showing the structure of an optical system in the optical head device shown in FIG. 1. FIG. 3 is a bottom view showing the optical head device shown in FIG. 1, in which the cover of the optical head device is detached. FIG. 4 is a side view showing a side face in the tracking direction of the optical head device shown in FIG. 1. FIG. 5 is a bottom view showing the bottom face of the optical head device which is shown in FIG. 1.

An optical head device 1 in accordance with an embodiment performs reproducing or recording information from or on an optical disk 30 such as a CD or a DVD, and is provided with a frame 15 on which an optical system 31 and the like, which will be described below, are mounted. The frame 15 is mounted to a main body of an optical disk recording and reproducing device (not shown) such that the frame 15 is capable of sliding along two guide shafts 24, 25 that are fixed to the main body so as to be parallel each other. In this present specification, the radial direction (tracking direction) of the optical disk 30 is set to be “X”-direction, the tangential direction (jitter direction) of the optical disk 30 is set to be “Y”-direction, and the orthogonal direction (focusing direction) with respect to the optical disk 30 is set to be “Z”-direction.

The optical system 31 in the optical head device 1 is provided, as a light source, with a first laser beam emitting element 2 which emits a first laser beam with a longer wavelength of 780 nm-800 nm for a CD, and a second laser beam emitting element 3 which emits a second laser beam with a shorter wavelength of 630 nm or 650 nm for a DVD.

In the optical system 31 in accordance with an embodiment, the first laser beam and the second laser beam are guided by a prism 6, which is an optical element for synthesizing for synthesizing optical paths, to a common optical path 14 directing to the optical disk 30. In the common optical path 14, a half mirror 7 for reflecting one part of the first laser beam or the second laser beam to the optical disk 30, a collimating lens 8 for forming a reflected light beam by the half mirror 7 to a parallel light, a rising mirror 9 for rising an emitted light beam from the collimating lens 8 to the optical disk 30, and an objective lens 10 for converging the laser beam converted to be a parallel light beam by the collimating lens 8 on the optical disk 30 are disposed in this order.

In order to guide the first laser beam emitted from the first laser beam emitting element 2 to the common optical path 14, a grating 4 for dividing the first laser beam into three beams and a relay lens 5 for converting the divergence angle of the laser beam divided into three beams are disposed in an optical path directing to the prism 6 from the first laser beam emitting element 2 in this order. A part of the first laser beam which is incident on the prism 6 through the grating 4 and the relay lens 5 is reflected by the prism 6 and guided to the common optical path 14.

Further, in order to guide the second laser beam emitted from the second laser beam emitting element 3 to the common optical path 14, a grating 11 for dividing the second laser beam into three beams is disposed in an optical path directing to the prism 6 from the second laser beam emitting element 3. A part of the second laser beam which is incident on the prism 6 through the grating 11 transmits through the prism 6 and guided to the common optical path 14.

A sensor lens 12 and a light receiving element 13 are disposed on a side position of the half mirror 7, and the return light beam which is reflected by the optical disk 30 is incident on the half mirror 7 through the objective lens 10, the rising mirror 9 and collimating lens 8. A part of the incident light beam transmits through the half mirror 7 and guided to the sensor lens 12 and the light receiving element 13. In other words, in this embodiment, the half mirror 7 is an optical path separating element.

The relay lens 5 is provided with a positive power by which the laser beam having a divergence angle smaller than that of the first laser beam, which is incident through the grating 4, is emitted to the prism 6. The relay lens 5 and the grating 4 and the first laser beam emitting element 2 are formed in an integrated manner as described below.

The sensor lens 12 causes the return light beam from the optical disk 30 to generate an astigmatism, and causes the magnification of the return light beam (magnification of a spot on the light receiving element 13 to a spot on the optical disk 30) to increase from about 8 times to about 17 times, and causes the coma aberration generated by the half mirror 7 to be corrected. A large and circular spot is formed on the light receiving element 13 by the sensor lens 12 and a focusing servo signal and a tracking servo signal with a satisfactory quality can be obtained.

The optical head device 1 includes an objective lens drive device 16 for driving the objective lens 10 in a focusing direction (Z-direction) and a tracking direction (X-direction) and mounted on the upper face side of the frame 15. The objective lens drive device 16 includes a tracking drive coil, a tracking driving magnet and a focusing drive coil and a focusing driving magnet, but their structure is well-known and thus a detailed description is omitted.

The frame 15 in this embodiment is, for example, a zinc frame which is molded by die-casting, and a recessed part 15c on which a part of the optical system 31 is mounted on the bottom face side (see FIG. 3). Some elements of the optical elements such as the prism 6, the half mirror 7, the collimating lens 8 and the rising mirror 9 which structure the optical system 31 are fixed in the recessed part 15c. Further, a fixing part 15a for fixing the first laser beam emitting element 2 and a fixing part 15b for fixing the second laser beam emitting element 3 are formed in the side face of the frame 15. The fixing part 15a and the fixing part 15b are formed to be perpendicular to each other.

A laser beam emitting unit which is integrally structured with the first laser beam emitting element 2, the grating 4 and the relay lens 5 are adhesively fixed to the fixing part 15a of the frame 15 with an adhesive 17 by using a zinc holder 18 which is, for example, molded by die-casting. Especially, the first laser beam emitting element is lightly press-fitted to a through-hole which is formed in the holder 18 (not shown) and is adhesively bonded with an anaerobic adhesive in a reinforced manner. Therefore, heat that is generated in the first laser beam emitting element 2 is dissipated on the holder 18 side from the contacting part formed by being lightly press-fitted.

A gap space 20 is formed between the holder 18 and the fixing part 15a of the frame 15 such that the optical axis in the holder 18 is adjustable in the optical axis direction of the first laser beam. After the optical axis of the first laser beam emitting element 2 is adjusted in the optical axis direction of the first laser beam through the holder 18, the holder 18 is adhesively fixed to the fixing part 15a by applying the adhesive 17 to the gap space 20. Therefore, heat which is generated in the first laser beam emitting element 2 and dissipated on the holder 18 side is dissipated on the frame 15. In this embodiment, the opposite part of the holder 18, which faces with the fixing part 15a and which forms the gap space 20 to the fixing part 15a, is formed as an opposite face 18a of the holder 18. Further, the fixing position of the holder 18 is capable of being also adjusted even in the direction perpendicular to the optical axis direction of the first laser beam.

In accordance with an embodiment, heat-conductive fillers superior in thermal conductivity compared to adhesive alone are contained in the adhesive 17 which is applied to the gap space 20. In this embodiment, the adhesive 17 contains 50-80 percent weight (wt %) of powder of aluminum nitride and their particle size is in the range from several μm to several tens of μm. Therefore, the thermal conductivity of the adhesive 17 with 1 w/m.k or more can be secured. Further, the heat-conductive fillers are provided a function that restrains the curing shrinkage percentage of the adhesive 17 in 5% or less in addition to securing of the thermal conductivity of the adhesive 17.

In this embodiment, an ultraviolet curing type of adhesive is used. However, since the ultraviolet light is shaded by the heat-conductive fillers contained in the adhesive 17 and thus sufficient curing of the adhesive 17 may be difficult. Therefore, for example, an epoxy based adhesive which is capable of cured by heat after the ultraviolet curing is used as the adhesive 17 to sufficiently being cured. In other words, in this embodiment, after the optical axis of the first laser beam emitting element 2 has adjusted, the adhesive 17 is quickly cured by irradiating ultraviolet light for about 30 seconds to make the position of the first laser beam emitting element 2 to be fixed and then the adhesive 17 is sufficiently cured by annealing at about 60° C. for about 30 minutes.

The second laser beam emitting element 3 is adhesively fixed to the fixing part 15b of the frame 15 through a heat conductive plate 27 which is formed in a flat plate shape and brought into contact with the frame 15 under the state that the second laser beam emitting element 3 is held to the holder 26 which is formed by zinc die-casting.

A circuit board 23 on which a laser driver 22 for driving the first laser beam emitting element 2 and the second laser beam emitting element 3 is mounted is fixed to the bottom face of the frame 15 (see FIG. 3). In addition, a cover 32 is fixed to protect a part of the circuit board 23 and the optical elements such as the prism 6 which are fixed to the recessed part 15c (see FIG. 5). The cover 32 is formed in a flat plate shape by using a stainless-steel plate and a fixing part 32a for being fixed to the frame 15 is extended in a Z-direction. The cover 32 is fixed to the frame 15 by a mounting screw 34 and the fixing part 32a.

As described above, in the optical head device 1 in accordance with an embodiment, the first laser beam emitting element 2 is lightly press-fitted to the holder 18 which is formed by zinc die-casting and the holder 18 is adhesively fixed to the frame 15 with the adhesive 17 which contains aluminum nitride as metal powder. Therefore, even when the first laser beam emitting element 2 is fixed to the frame 15 by using the adhesive 17, heat generated in the first laser beam emitting element 2 is dissipated to the frame 15 through the aluminum nitride which is contained in the adhesive 17. As a result, superior heat dissipation effect can be obtained without using heat dissipation grease. Besides, the shrinkage at the time of curing and the shrinkage due to aging of the adhesive 17 are restrained by aluminum nitride.

Further, in this embodiment, the adhesive 17 is disposed in the gap space 20 formed to the frame 15 for adjusting the optical axis in the optical axis direction of the first laser beam emitting element 2. Therefore, the optical head device 1 can be made compact in the radial direction by disposing the adhesive 17 in the gap space 20.

In addition, in this embodiment, the adhesive 17 is an ultraviolet curing type of epoxy system adhesive which is also capable of being fully cured by heat afterward. Therefore, even when light is shaded by the aluminum nitride contained in the adhesive 17 and the adhesive 17 is not sufficiently cured by light or partially cured, the adhesive 17 can be sufficiently cured by heat which is applied to the adhesive 17 afterward. As a result, the optical axis of the first laser beam emitting element 2 is adjusted and the adhesive 17 is quickly cured by ultraviolet rays to cause the first laser beam emitting element 2 to be fixed at an appropriate position. After that, the adhesive 17 can be completely cured by applying heat or the like.

In addition, in this embodiment, the holder 18 is provided on which the first laser beam emitting element 2 is fitted to a through-hole formed in the holder 18 in the optical axis direction and the adhesive 17 is disposed in the gap space 20 between the fixing part 15a and the opposite face 18a of the holder 18 that faces the fixing part 15a in the optical axis direction. In accordance with an embodiment, since the holder 18 is formed in a rectangular shape that can be easily gripped by an optical axis adjusting equipment, the holder 18 can be easily and surely held in comparison with the case that the first laser beam emitting element itself is gripped by the optical axis adjusting equipment. As a result, workability of optical axis adjustment can be improved. In addition, when the holder 18 is formed larger than the stem of the first laser beam emitting element 2 in the direction perpendicular to the optical axis direction, the contacting area of the adhesive 17 with the holder 18 can be secured. Therefore, the heat generated from the first laser beam emitting element 2 can be effectively dissipated to the frame 15 through the holder 18.

The present invention has been described in detail with reference to the embodiments, but the present invention is not limited to the embodiments described above and many modifications can be made without departing from the present invention.

For example, in the embodiment described above, the laser beam emitting element is adhesively fixed to the frame with the adhesive containing the heat-conductive fillers. However, the light receiving element may be adhesively fixed to the frame by using the adhesive containing the heat-conductive fillers. Also in this case, heat generated in the light receiving element can be dissipated to the frame through the adhesive containing the heat-conductive fillers. Further, in the embodiment described above, the powder of aluminum nitride is contained in the adhesive 17. However, various conductive fillers, for example, powder comprising boron nitride, silicon nitride or silicon, ceramics such as aluminum oxide, or metal such as gold, silver, copper or stainless steel, which are superior in heat conductivity than adhesive alone such as epoxy or other adhesives, may be used.

Further, in the embodiment described above, the frame 15 and the holder 18 is formed by zinc die-casting, but the material of the frame 15 and the holder 18 is not limited to the zinc die-casting and they may be formed by aluminum die-casting.

Further, in the embodiment described above, an ultraviolet ray curing type of adhesive is used as an adhesive, but another adhesive may be used which is capable of being cured by a short time with light other than ultraviolet light, electron beam or the like. In the embodiment described above, epoxy system adhesive is used because the adhesive can be completely cured by heat after having cured by ultraviolet light. However, adhesive other than epoxy system adhesive may be used when it is capable of being cured completely.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device, for use with an optical disk, comprising:
a laser beam emitting element as a light source;
a light receiving element structured for receiving a reflected light beam which is emitted from the laser beam emitting element to the optical disk and reflected by the optical disk;
a frame on which the laser beam emitting element and the light receiving element are mounted; and
an adhesive which contains heat-conductive fillers having thermal conductivity to adhesively fix the laser beam emitting element or the light receiving element to the frame and to transfer heat between at least one of the elements and the frame.

2. The optical head device according to claim 1, wherein the heat-conductive fillers comprise powder of metal or nitride.

3. The optical head device according to claim 1, wherein the adhesive is disposed in a gap space which is formed between the frame and the laser beam emitting element to adjust an optical axis of the laser beam emitting element in an optical axis direction.

4. The optical head device according to claim 1, wherein the adhesive is a photo-curing type of adhesive which is capable of being at least partially cured by applying heat or ultraviolet light.

5. The optical head device according to claim 1, further comprising
a holder which is provided with a through-hole formed in an optical axis direction on which the laser beam emitting element is mounted, and the holder being provided with an opposite face facing the frame in an optical axis direction,
wherein the adhesive is disposed in the gap space between the opposite face and the frame.

6. A manufacturing method for an optical head device, for use with an optical disk, comprising:
preparing a laser beam emitting element as a light source, a light receiving element for receiving a reflected light beam which is emitted from the laser beam emitting element to the optical disk and reflected by the optical disk, and a frame on which the laser beam emitting element and the light receiving element are mounted;
providing a photo-curing type of adhesive, which contains heat-conductive fillers and is capable of being cured by applying heat, between the laser beam emitting element or the light receiving element and the frame;
curing the adhesive at least partially by irradiating light to the adhesive; and then
further curing the adhesive by applying heat.

7. The manufacturing method for an optical head device according to claim 6, further comprising
preparing a holder which is provided with a through-hole formed in an optical axis direction on which the laser beam emitting element is mounted, and the holder being provided with an opposite face facing the frame in an optical axis direction;
fitting the holder to the frame such that a gap space is formed between the opposite face of the holder and the frame; and
applying the photo-curing type of adhesive to the gap space.

8. The optical head device according to claim 1, wherein the heat conductive fillers comprise boron nitride, silicon nitride or silicon.

9. The optical head device according to claim 1, wherein the heat conductive fillers comprise ceramics.

10. The optical head device according to claim 1, wherein the heat conductive fillers comprise aluminum oxide.

11. The optical head device according to claim 1, wherein the heat conductive fillers comprise metal.

12. The optical head device according to claim 1, wherein the heat conductive fillers comprise gold.

13. The optical head device according to claim 1, wherein the heat conductive fillers comprise silver.

14. The optical head device according to claim 1, wherein the heat conductive fillers comprise copper.

15. The optical head device according to claim 1, wherein the heat conductive fillers comprise stainless steel.
